(19) United States
(12) Patent Application Publication
(10) Pub. No.: US 2024/0416617 A1
(43) Pub. Date: Dec. 19, 2024

(54) BULLETPROOF, STAB-PROOF, AND CUT-PROOF STRUCTURE

(71) Applicant: JIA-YUAN LEE, Taipei (TW)

(72) Inventor: JIA-YUAN LEE, Taipei (TW)

(21) Appl. No.: 18/336,858

(22) Filed: Jun. 16, 2023

(51) Int. Cl. B32B 5/26; B32B 5/02; F41H 5/04

(52) U.S. Cl. CPC B32B 5/26; B32B 5/02; F41H 5/0485; B32B 2250/20; B32B 2307/558; B32B 2307/581; B32B 2571/02

(57) ABSTRACT

A bulletproof, stab-proof, and cut-proof structure comprises at least one bulletproof material layer and two stab-proof and cut-proof material layers. The bulletproof material layer is positioned between the two stab-proof and cut-proof material layers. Another structure comprises at least two bulletproof material layers and a stab-proof and cut-proof material layer. The stab-proof and cut-proof material layer is positioned between the two bulletproof material layers. Another structure comprises a plurality of bulletproof material layers and a plurality of stab-proof and cut-proof material layers. Each bulletproof material layer and each stab-proof and cut-proof material layer are arranged in a regular or irregular interleaved manner. Another structure comprises a plurality of stab-proof and cut-proof material layers. Each of the stab-proof and cut-proof material layers is composed of multiple layers of stab-proof and cut-proof material layers and stacked together.

### BACKGROUND OF THE INVENTION

### (a) Field of the Invention

The present invention relates to the field of bulletproof material, stab-proof material, and cut-proof material, in particular, to a bulletproof, stab-proof, and cut-proof structure with the bulletproof effect, the stab-proof effect, and the cut-proof effect.

### (b) Description of the Related Art

In general, bulletproof material or bulletproof equipment can effectively prevent or reduce the damage caused by machine guns and ammunition to the protected area at medium and long distances. Moreover, the stab-proof and cut-proof material or the stab-proof and cut-proof equipment can effectively prevent the damage caused by knives and other weapons at close range. Both types of protective products can reduce the risk of injury, severe injury, or death for the users. However, the existing stab-proof and cut-proof material or the existing stab-proof and cut-proof equipment do not have bulletproof capabilities. Therefore, it remains a challenge to propose a protective structure that combines bulletproof, stab-proof, and cut-proof functionalities, while seeking a balance between protective performance and lightweight design.

### SUMMARY OF THE INVENTION

The present invention achieves the above objectives by proposing a bulletproof, stab-proof, and cut-proof structure through the arrangement of different protective material layers. In one embodiment, the bulletproof, stab-proof, and cut-proof structure comprises a bulletproof material layer, a stab-proof and cut-proof material layer, and a second stab-proof and cut-proof material layer, wherein the bulletproof material layer is positioned between the stab-proof and cut-proof material layer and the second stab-proof and cut-proof material layer.

Moreover, the bulletproof, stab-proof, and cut-proof structure further comprises a second bulletproof material layer and a third stab-proof and cut-proof material layer, wherein the second bulletproof material layer is positioned between the second stab-proof and cut-proof material layer and the third stab-proof and cut-proof material layer.

The present invention achieves the above objectives by proposing another bulletproof, stab-proof, and cut-proof structure through the arrangement of different protective material layers. In one embodiment, the bulletproof, stab-proof, and cut-proof structure comprises a bulletproof material layer, a second bulletproof material layer, and a stab-proof and cut-proof material layer, wherein the stab-proof and cut-proof material layer is positioned between the bulletproof material layer and the second bulletproof material layer.

The present invention achieves the above objectives by proposing another bulletproof, stab-proof, and cut-proof structure through the arrangement of different protective material layers. In one embodiment, the bulletproof, stab-proof, and cut-proof structure comprises a plurality of bulletproof material layers and a plurality of stab-proof and cut-proof material layers, wherein each bulletproof material layer and each stab-proof and cut-proof material layer is arranged in a regular or irregular interleaved manner.

The present invention achieves the above objectives by proposing another bulletproof, stab-proof, and cut-proof structure. In one embodiment, the bulletproof, stab-proof, and cut-proof structure comprises a plurality of stab-proof and cut-proof material layers, which are respectively composed of multiple layers of stab-proof and cut-proof material layers and stacked together. This arrangement renders the plurality of stab-proof and cut-proof material layers to reach a certain number of layers and reach a certain thickness thereby having bulletproof functionality.

In addition, in a preferred embodiment, one or the combination of the bulletproof material layer and the second bulletproof material layer can be composed of multiple layers of bulletproof material and stacked together.

In addition, in a preferred embodiment, one or any combination of the stab-proof and cut-proof material layer, the second stab-proof and cut-proof material layer, and the third stab-proof and cut-proof material layer can be composed of multiple layers of stab-proof and cut-proof material and stacked together.

Several exemplary embodiments accompanied by figures are described in detail below to further describe the disclosure in detail.

### BRIEF DESCRIPTION OF THE FIGURES

The accompanying drawings are included to provide a further understanding of the present invention and are incorporated in and constitute a part of this specification. The drawings illustrate embodiments of the disclosure and, together with the description, serve to explain the principles of the invention.

FIG. 1 is a schematic diagram of a bulletproof, stab-proof, and cut-proof structure according to an embodiment of the present invention.

FIG. 2 is a schematic diagram of a bulletproof, stab-proof, and cut-proof structure according to the second embodiment of the present invention.

FIG. 3 is a schematic diagram of a bulletproof, stab-proof, and cut-proof structure according to the third embodiment of the present invention.

FIG. 4 is a schematic diagram of a bulletproof, stab-proof, and cut-proof structure according to the fourth embodiment of the present invention.

FIG. 5 is a schematic diagram of a bulletproof, stab-proof, and cut-proof structure according to the fifth embodiment of the present invention.

FIG. 6 is a schematic diagram of a bulletproof, stab-proof, and cut-proof structure according to the sixth embodiment of the present invention.

FIG. 7 is a schematic diagram of a bulletproof, stab-proof, and cut-proof structure according to the seventh embodiment of the present invention.

FIG. 8 is a schematic diagram of a bulletproof, stab-proof, and cut-proof structure according to the eighth embodiment of the present invention.

FIG. 9 is a schematic diagram of a bulletproof, stab-proof, and cut-proof structure according to the ninth embodiment of the present invention.

FIG. 10 is a schematic diagram of a bulletproof, stab-proof, and cut-proof structure according to the tenth embodiment of the present invention.

### DETAILED DESCRIPTION OF THE PREFERRED EMBODIMENT

The following embodiments are provided merely to help those skilled in the art easily understand the technical spirit of the present invention, and the present invention is not limited to these embodiments. The disclosure includes all changes, modifications, and equivalents coming within the terms of the appended claims.

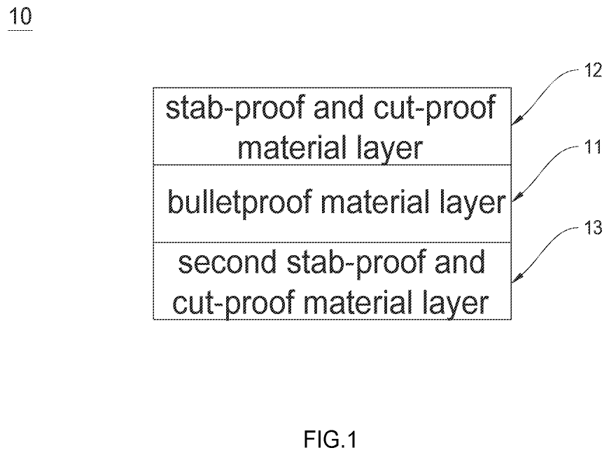

As shown in FIG. 1, according to an embodiment of the present invention, a bulletproof, stab-proof, and cut-proof structure (10) includes a bulletproof material layer (11), a stab-proof and cut-proof material layer (12), and a second stab-proof and cut-proof material layer (13), wherein the bulletproof material layer (11) can be positioned between the stab-proof and cut-proof material layer (12) and the second stab-proof and cut-proof material layer (13).

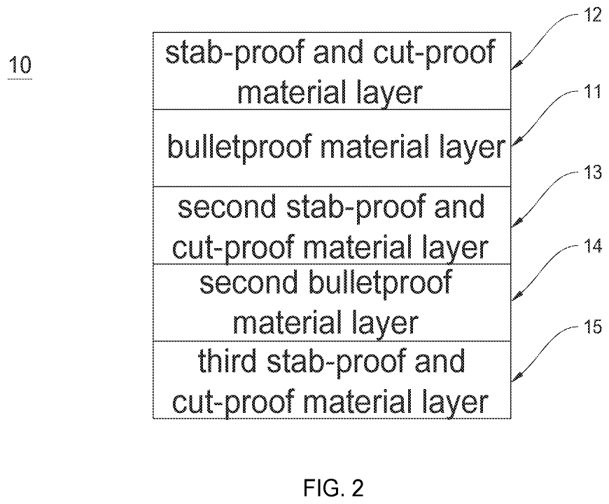

As shown in FIG. 2, according to the second embodiment of the present invention, a bulletproof, stab-proof, and cut-proof structure (10) compared to FIG. 1 can further comprise a second bulletproof material layer (14) and a third stab-proof and cut-proof material layer (15), wherein the second bulletproof material layer (14) can be positioned between the second stab-proof and cut-proof material layer (13) and the third stab-proof and cut-proof material layer (15).

Further, based on the second embodiment shown in FIG. 2, the present invention further proposes another preferred embodiment, wherein the stab-proof and cut-proof material layer (12), the second stab-proof and cut-proof material layer (13), and the third stab-proof and cut-proof material layer (15) can be respectively composed of one layer of stab-proof and cut-proof material respectively. Moreover, the bulletproof material layer (11) and the second bulletproof material layer (14) can be respectively composed of fifteen layers of bulletproof material. In this way, the protective structure having 33 layers of protective materials would have bulletproof, stab-proof, and cut-proof functionalities, wherein this protective structure can be fixed (for example, be fixed after becoming a synthetic vacuum state or fixed in the way of sewing) and then be inserted into a sleeve body that is composed of waterproof materials (such as but not limited to textile materials, synthetic leather, plastic, and other waterproof materials), and then be sealed around with high frequency, so as to achieve the effect of completely waterproof, bulletproof, stab-proof, and cut-proof, but the above number of layers is only for example but should not be limited thereto.

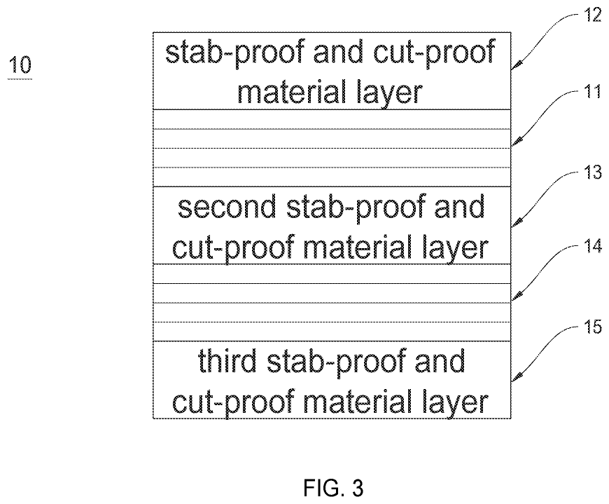

As shown in FIG. 3, according to the third embodiment of the present invention, compared to the embodiment shown in FIG. 2, one or the combination of the bulletproof material layer (11) and the second bulletproof material layer (14) in the present embodiment can be composed of multiple layers of bulletproof material and stacked together.

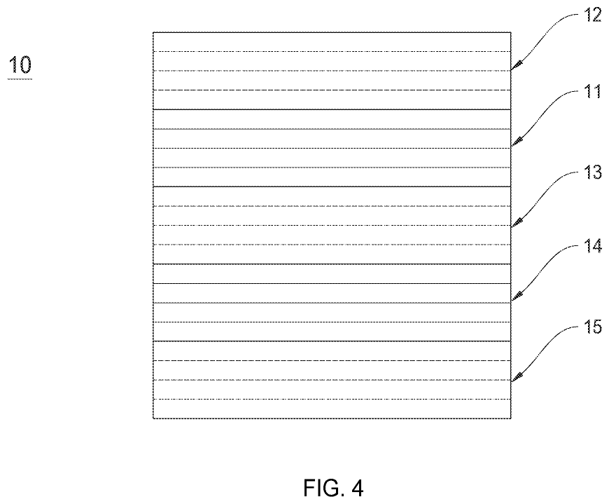

As shown in FIG. 4, according to the fourth embodiment of the present invention, compared to the embodiment shown in FIG. 3, one or any combination of the stab-proof and cut-proof material layer (12), the second stab-proof and cut-proof material layer (13), and the third stab-proof and cut-proof material layer (15) in the present embodiment can be composed of multiple layers of stab-proof and cut-proof material and stacked together.

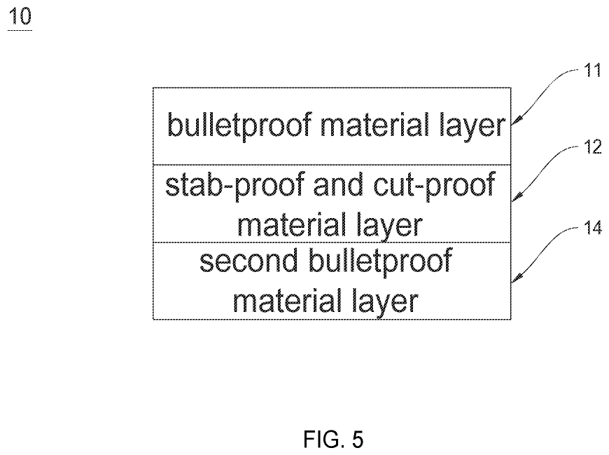

As shown in FIG. 5, according to the fifth embodiment of the present invention, a bulletproof, stab-proof, and cut-proof structure (10) includes a bulletproof material layer (11), a stab-proof and cut-proof material layer (12), and a second bulletproof material layer (14), wherein the stab-proof and cut-proof material layer (12) is positioned between the bulletproof material layer (11) and the second bulletproof material layer (14).

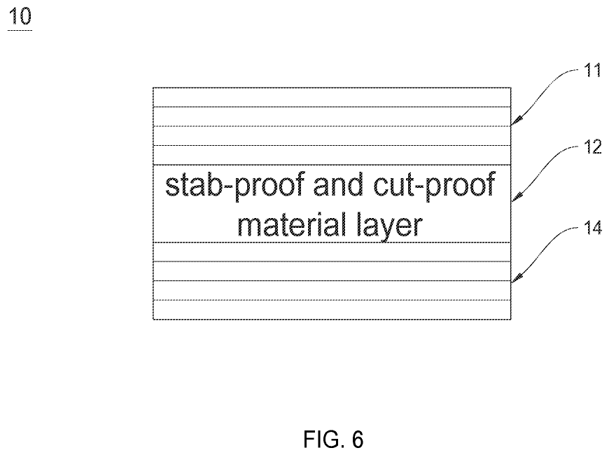

As shown in FIG. 6, according to the sixth embodiment of the present invention, compared to the embodiment shown in FIG. 5, one or the combination of the bulletproof material layer (11) and the second bulletproof material layer (14) in the present embodiment can be composed of multiple layers of bulletproof material and stacked together.

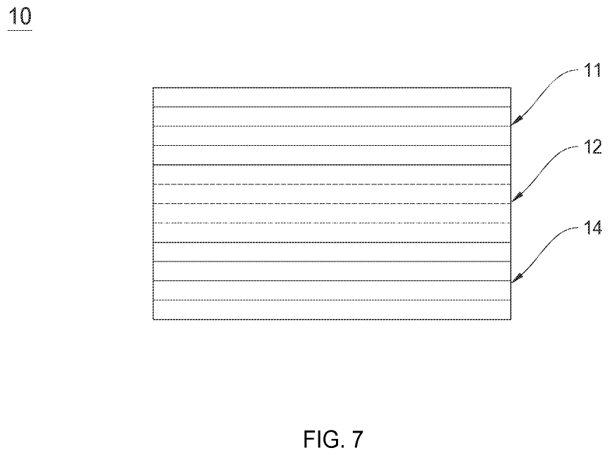

As shown in FIG. 7, according to the seventh embodiment of the present invention, compared to the embodiment shown in FIG. 6, the stab-proof and cut-proof material layer in the present embodiment can be composed of multiple layers of stab-proof and cut-proof material and stacked together.

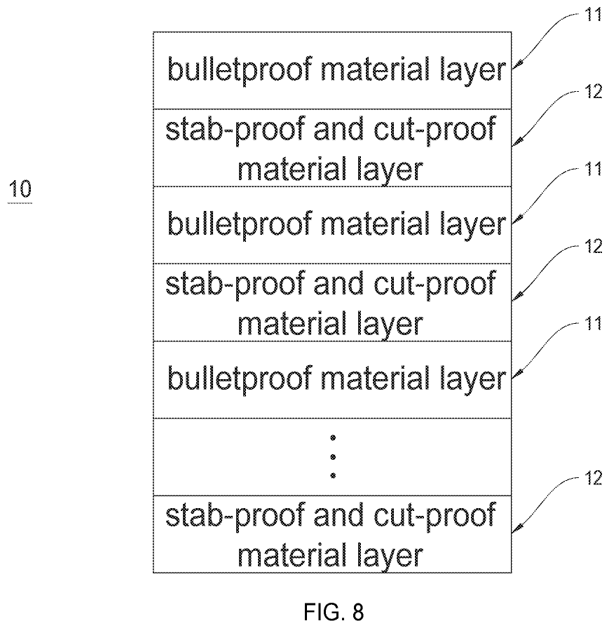

As shown in FIG. 8, according to the eighth embodiment of the present invention, a bulletproof, stab-proof, and cut-proof structure (10) includes a plurality of bulletproof material layers (11) and a plurality of stab-proof and cut-proof material layers (12), wherein each bulletproof material layer (11) and each stab-proof and cut-proof material layer (12) can be respectively arranged in a regular or irregular interleaved manner.

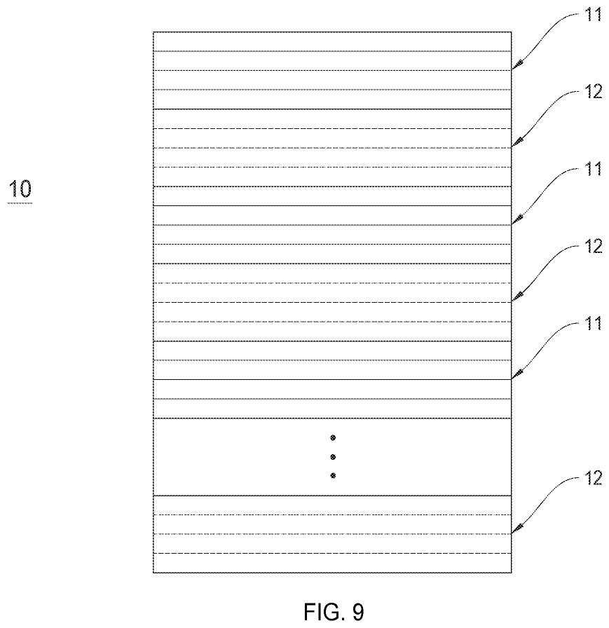

As shown in FIG. 9, according to the ninth embodiment of the present invention, compared to the embodiment shown in FIG. 8, each of the bulletproof material layers (11) in the present embodiment can be composed of multiple layers of bulletproof material and stacked together.

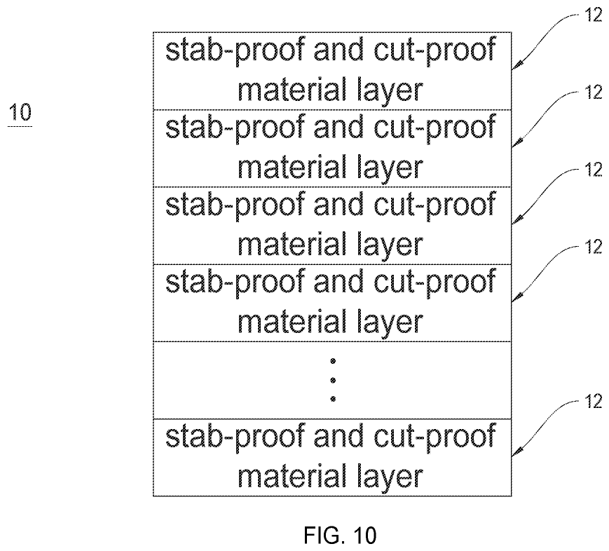

As shown in FIG. 10, according to the tenth embodiment of the present invention, a bulletproof, stab-proof, and cut-proof structure (10) comprises a plurality of stab-proof and cut-proof material layers (12), which are respectively composed of multiple layers of stab-proof and cut-proof material layers and stacked together. This arrangement renders the plurality of stab-proof and cut-proof material layers to reach a certain number of layers and reach a certain thickness and thereby have bulletproof functionality.

As an example, the above-mentioned stab-proof and cut-proof materials may be ARMORTEX® cloth with stab-proof and cut-proof functionalities, ARMORTEX® anti-cutting cloth, or Kevlar® stab-proof and cut-proof cloth but should not be limited thereto.

As an example, the above-mentioned bulletproof material may be Kevlar® bulletproof fabric, Tensylon® bulletproof fabric, or other ultra-high molecular weight polyethylene (UHMW-PE) fabric but not limited to such materials.

What is claimed is:

1. A bulletproof, stab-proof, and cut-proof structure, comprising:
a bulletproof material layer;
a stab-proof and cut-proof material layer; and
a second stab-proof and cut-proof material layer;
wherein the bulletproof material layer is positioned between the stab-proof and cut-proof material layer and the second stab-proof and cut-proof material layer.

2. The bulletproof, stab-proof, and cut-proof structure of claim 1, further comprising a second bulletproof material layer and a third stab-proof and cut-proof material layer, wherein the second bulletproof material layer is positioned between the second stab-proof and cut-proof material layer and the third stab-proof and cut-proof material layer.

3. The bulletproof, stab-proof, and cut-proof structure of claim 2, wherein one or the combination of the bulletproof material layer and the second bulletproof material layer are composed of multiple layers of bulletproof material and stacked together.

4. The bulletproof, stab-proof, and cut-proof structure of claim 3, wherein one or any combination of the stab-proof and cut-proof material layer, the second stab-proof and cut-proof material layer, and the third stab-proof and cut-proof material layer are composed of multiple layers of stab-proof and cut-proof material and stacked together.

5. A bulletproof, stab-proof, and cut-proof structure, comprising:
a bulletproof material layer;
a second bulletproof material layer; and
a stab-proof and cut-proof material layer;
wherein the stab-proof and cut-proof material layer is positioned between the bulletproof material layer and the second bulletproof material layer.

6. The bulletproof, stab-proof, and cut-proof structure of claim 5, wherein the bulletproof material layer and the second bulletproof material layer are respectively composed of multiple layers of bulletproof material and stacked together.

7. The bulletproof, stab-proof, and cut-proof structure of claim 6, wherein the stab-proof and cut-proof material layer is composed of multiple layers of stab-proof and cut-proof material and stacked together.

8. A bulletproof, stab-proof, and cut-proof structure, comprising:
a plurality of bulletproof material layers; and
a plurality of stab-proof and cut-proof material layers;
wherein each of the bulletproof material layers and each of the stab-proof and cut-proof material layers is arranged in a regular or irregular interleaved manner.

9. The bulletproof, stab-proof, and cut-proof structure of claim 8, wherein each of the bulletproof material layers is composed of multiple layers of bulletproof material and stacked together, and each of the stab-proof and cut-proof material layers is composed of multiple layers of stab-proof and cut-proof material and stacked together.

10. A bulletproof, stab-proof, and cut-proof structure, comprising:
a plurality of stab-proof and cut-proof material layers, wherein each of the stab-proof and cut-proof material layers is composed of multiple layers of stab-proof and cut-proof material layers and stacked together, rendering the plurality of stab-proof and cut-proof material layers to have bulletproof functionality.
